(19) United States
(12) Patent Application Publication
(10) Pub. No.: US 2017/0215345 A1
(43) Pub. Date: Aug. 3, 2017

(54) Connector Block For Assembling a Garden Bed or a Planter Box

(71) Applicant: OLDCASTLE BUILDING PRODUCTS CANADA INC., Saint-John (CA)

(72) Inventors: John Penterman, Montreal (CA); Oscar Quan Rosales, Montreal (CA); Martin Latour, Montreal (CA)

(21) Appl. No.: 15/009,244

(22) Filed: Jan. 28, 2016

(51) Int. Cl. A01G 1/08; E04C 1/00

(52) U.S. Cl. CPC A01G 1/08; E04C 1/00

(57) ABSTRACT

A connector block is provided, for joining boards of a garden bed or of a planter box. The connector block has a top face, a bottom face and four lateral faces, each face being provided with a slot for receiving the extremity of a board. The connector block is also provided with a through hole extending from the top face to the bottom face for receiving a grounding rod bar.

### TECHNICAL FIELD OF THE INVENTION

The present invention relates to concrete-based connector blocks. More particularly, the invention relates to concrete-based connector blocks for joining boards for forming a garden bed or a planter box.

### BACKGROUND OF THE INVENTION

Landscaping of homes and buildings requires making choices that are often viewed as permanent since landscaping components such as trees, paths, planting beds or gardens can be difficult to reconfigure year after year to refresh a landscaping.

Movable garden beds and movable planter boxes have been providing a solution for this problem. A movable garden bed or planter box consists of a receptacle in the form of an enclosure that is laid on the ground. The garden bed or planter box is typically formed with connector blocks or connector posts and wood boards or planks inserted into the connector blocks or connector posts and extending therefrom to form the enclosure. The garden bed or planter box is configured to receive soil and to provide an elevated garden bed with respect to the ground, which can be aesthetically pleasing in a landscape.

A garden bed or planter box can offer the convenience of being dismantled and reassembled a plurality of times. Thus, a user can install a garden bed or a planter box for summer time and, for instance, dismantle it and store it for winter time. In addition, a garden bed or a planter box may offer the convenience of being installed at one location for a period of time, dismantled, and reinstalled at a different location around a house or building. In addition, these types of garden beds or planter boxes are typically installed above ground, and thus they do not require digging the ground or much ground preparation. A garden bed or a planter box thus offers the possibility of refreshing the landscaping of a house or building. However, many implementations of garden beds or planter boxes fail to offer a simple and easy installation and dismantlement thereof.

There is a need to provide a connector block for forming a garden bed or a planter box offering more convenient assembly and disassembly thereof while remaining aesthetically pleasing.

### BRIEF SUMMARY OF THE INVENTION

According to a possible embodiment of the invention, a connector block for assembling a garden bed or a planter box is provided. The connector block is especially configured for use in combination with boards and grounding rod bars. The connector block has a body made of concrete-based material, with four lateral faces extending between a top face and a bottom face. The body is also provided with a through hole extending from the top face to the bottom face, for receiving a grounding rod bar. Each of the four lateral faces is provided with a slot extending vertically from the top face to the bottom face, for receiving an extremity of one of the boards. Each slot is defined by a continuous slot wall which is recessed from a corresponding one of said four lateral faces.

According to a possible embodiment, the body of the connector block includes four corner posts, the slot of a respective one of the lateral faces being formed between adjacent ones of said corner posts.

According to a possible embodiment, the body includes a central post, the four corner posts protruding from corners of said central post, and the through hole is provided in said central post.

According to a possible embodiment, the four corner posts have respective top flat top surfaces, allowing the connector block to be stacked.

According to a possible embodiment, the central post has a top surface which is recessed relative to the top flat surfaces of the four corner posts.

According to a possible embodiment, the slot wall comprises a two opposed lateral walls part of the adjacent corner posts and a back wall part of the central post.

According to a possible embodiment, each slot has at least one recessed portion for receiving a bracket mounted at the extremity of one of said boards. Optionally, the slot may have a T-shaped cross-section when viewing the block from its top face.

According to a possible embodiment, the slot wall can include at least one tapered projection protruding therefrom and extending vertically along at least a portion of the slot, for wedging at least one lateral side of one of said boards. Optionally, two face to face projects are protruding toward to the bottom of the slot.

According to a possible embodiment of the invention, an assembly kit is provided for forming a raised garden bed or planter box is provided. The assembly kit includes a plurality of connectors as described above, a plurality of boards, and also preferably grounding rod bars. Optionally, the kit includes brackets to be mounted or affixed at the extremities of the boards.

According to a possible embodiment of the invention, a garden bed or a planter box are provided, as well as a method for assembling the garden bed or planter box.

As part of the present disclosure, embodiments are described in detail according to the aspects described above. According to the invention, many other embodiments are also possible, several of which will be summarily presented.

### BRIEF DESCRIPTION OF THE FIGURES

These and other objects and advantages of the invention will become apparent upon reading the detailed description and upon referring to the drawings.

FIG. 1 is a top perspective view of a connector block in accordance with a first embodiment of the present invention, with boards positioned above the connector block.

FIG. 2 is a front elevation view of the connector block of FIG. 1.

FIG. 3 is a bottom view of the connector block of FIG. 1.

FIG. 4 is top view of the connector block of FIG. 1.

FIG. 5 is a cross-section view of the connector block of FIG. 1 along the cross-section line 5-5 of FIG. 4.

FIG. 6 is a top perspective view of a garden bed or planter box shown during assembly, made of a plurality of connector blocks and boards, such as shown in FIG. 1.

FIG. 7 is a top perspective view of a connector block in accordance with a second embodiment of the present invention, with boards comprising brackets at an extremity thereof and positioned above the connector block.

FIG. 8 is a front elevation view of the connector block of FIG. 7.

FIG. 9 is a bottom view of the connector block of FIG. 7.

FIG. 10 is top view of the connector block of FIG. 7.

FIG. 11 is a cross-section view of the connector block of FIG. 7 along the cross-section line 11-11 of FIG. 10.

FIG. 12A to FIG.12F show the different steps for assembling a garden bed or a planter box, according to a possible embodiment.

It will be noted that throughout the appended drawings, like features are identified by like reference numerals.

### DETAILED DESCRIPTION OF THE PREFERRED EMBODIMENTS

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

In addition, although the optional configurations as illustrated in the accompanying drawings comprises various components and although the optional configurations of the connector block as shown may consist of certain geometrical configurations as explained and illustrated herein, not all of these components and geometries are essential and thus should not be taken in their restrictive sense, i.e. should not be taken as to limit the scope of the present disclosure. It is to be understood that other suitable components, as well as other suitable geometrical configurations may be used for the connector block, and corresponding parts, as briefly explained and as can be easily inferred herefrom, without departing from the scope of the disclosure.

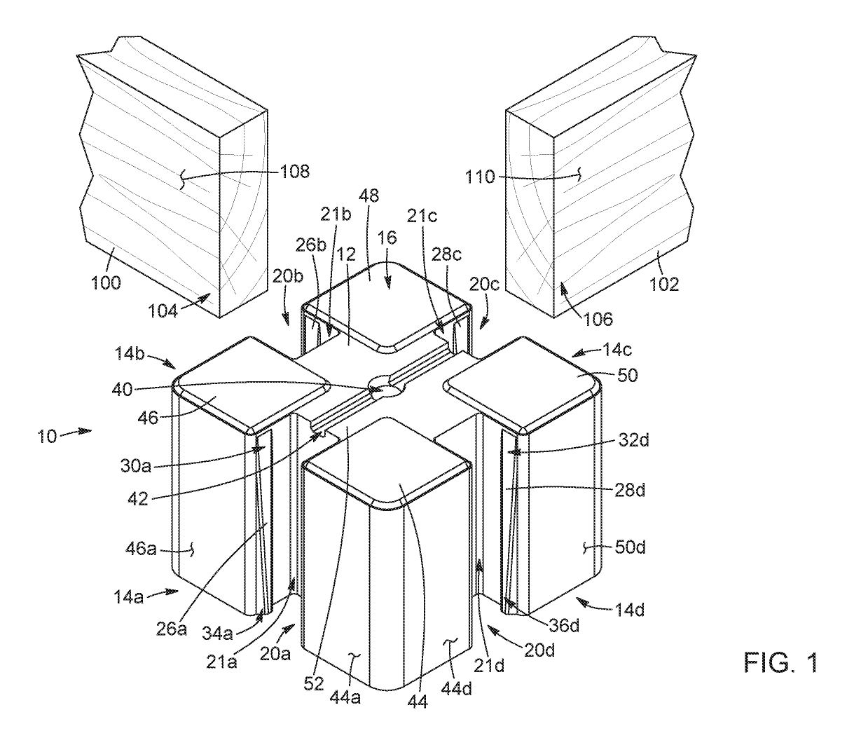

As it will be better understood in view of the following description and referring to FIG. 1, a first embodiment of a connector block 10 for joining boards 100, 102 is provided. In the present case, the assembly of a plurality of boards 100, 102 with a plurality of connector blocks 10 form a garden bed or a planter box, as will be described in more detail below. The different embodiments of the connector block are especially useful for the assembly of raised garden beds.

Referring to FIG. 1, two boards 100, 102 are shown, positioned above the connector block 10 at about 90 degrees from each other, thus defining a corner of a garden bed or a planter box. The boards 100, 102 are understood to be any kind of board that can be suited to be used outdoors. Typically, the boards are made of wood, but other types of boards can be considered, such as concrete or porcelain boards. Other materials, such as polymers, can also be contemplated to form the boards. The boards can consist of planks or panels made from a variety of materials. While typically the boards have a length exceeding their width, with a width varying from 0.5 to 2 inches, boards of different sizes can be used with the connector blocks. In some embodiments, the boards 100, 102 have one of their dimensions, such as their width, substantially corresponding to a height of the connector block 10.

In the following description, it is to be understood that letters a, b, c, d used in the reference numerals relate to the different lateral faces of the connector block 10 on which a given feature is found.

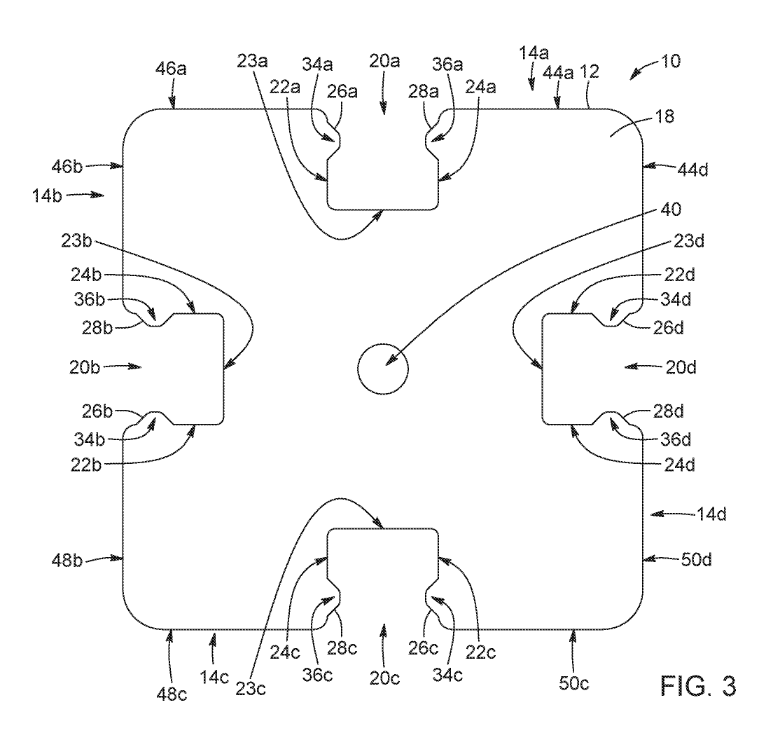

Referring to FIGS. 1 and 3, and in accordance with a possible embodiment, the connector block 10 comprises a body 12 made of a concrete-based material. The body 12 has four lateral faces 14a, 14b, 14c, 14d extending between a top 16 face and a bottom face 18 of the connector block 10. In other embodiments, it can be considered to form the connector block with a different number of sides or faces. Each one of the four lateral faces 14a, 14b, 14c, 14d of the connector block 10 includes a slot 20a, 20b, 20c, 20d extending vertically from the top face 16 to the bottom face 18, for receiving an extremity 104, 106 of one of said boards 100, 102. Preferably, the connector block includes four slots, spaced apart by about 90° each, so as to be able to form rectangular or square garden beds or planters. Each slot 20a, 20b, 20c, 20d is defined by a slot wall 21a, 21b, 21c, 21d which is recessed from a corresponding one of said four lateral faces 14a, 14b, 14c, 14d. In the present case, the slot wall includes a back wall and two lateral walls. However, in other embodiments, the slot walls can be continuous, and formed with a curved or semi-circular cross-section.

In this particular embodiment, each one of the slot walls 21a, 21b, 21c, 21d includes at least one tapered projection protruding therefrom and extending vertically along at least a portion of the slot 20a, 20b, 20c, 20d, for wedging at least one lateral side 108, 110 of one of said boards 100, 102. The tapered projections are optional, and boards can be simply slid and received into the slots 20a-20d. The projections preferably include a portion which becomes progressively smaller. This narrower, pointed portion allows for pinching of the board within the slot, allowing retaining the board without having to use hardware, such as nails and/or screws. While a single projection can be provided on a lateral side of the slot, is it preferred to use two projections, one on each lateral side of the slot, so as to be able to pinch board on both its inner side and outer/exposed side.

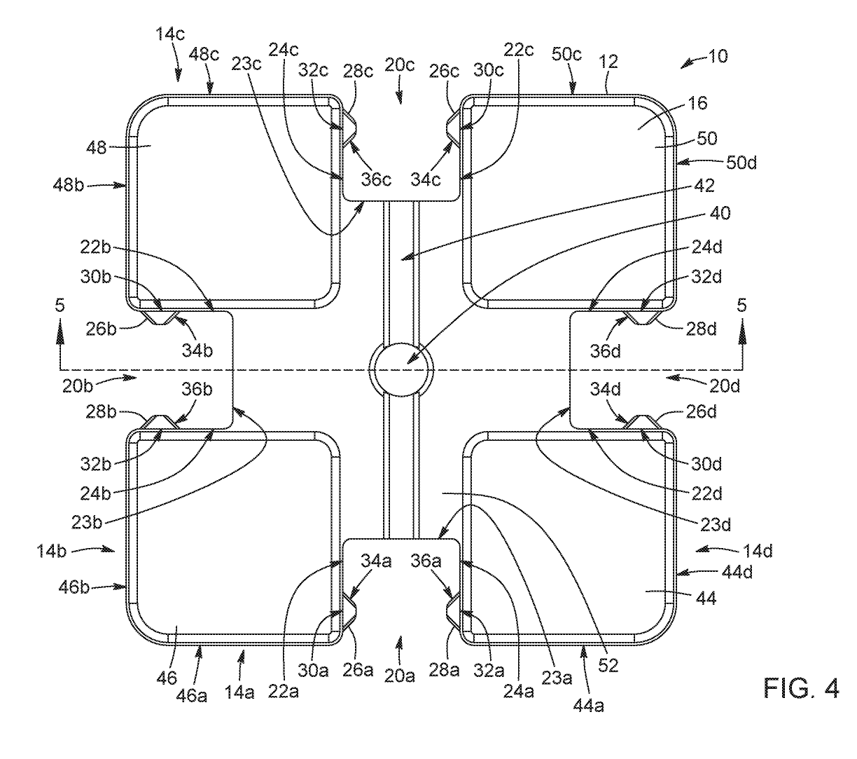

In the embodiment shown in FIGS. 1 to 5, the slot has a substantially rectangular cross-section (as best shown in FIGS. 3 and 4). Each one of the slot walls 21a, 21b, 21c, 21d has opposed lateral walls 22a, 24a, 22b, 24b, 22c, 24c, 22d, 24d and a respective back wall 23a, 23b, 23c, 23d (better shown in FIG. 3). Each vertical slot 20a, 20b, 20c, 20d respectively includes a first tapered projection 26a, 26b, 26c, 26d and a second tapered projection 28a, 28b, 28c, 28d (better shown in FIG. 3), each provided on a respective one of said opposed lateral walls 22a, 24a, 22b, 24b, 22c, 24c, 22d, 24d, for wedging both lateral sides of one of said boards 100, 102. Thus, it is to be understood that each extremity 104, 106 of the boards 100, 102 can be slidably engaged within one of the slots 20a, 20b, 20c, 20d and extending outwardly therefrom.

Still referring to FIGS. 1 to 3, the two opposed lateral walls 22a, 24a, 22b, 24b, 22c, 24c, 22d, 24d of each one of the slot walls 21a, 21b, 21c, 21d define a width of each one of the slots 20a, 20b, 20c, 20d. In the illustrated embodiment, each one of the first and second tapered projections 26a, 28a, 26b, 28b, 26c, 28c, 26d, 28d has a corresponding top portion 30a, 32a, 30b, 32b, 30c, 32c, 30d, 32d proximate to the top face 16, and a corresponding bottom portion 34a, 36a, 34b, 36b, 34c, 36c, 34d, 36d proximate to the bottom face 18. It can be appreciated that each one of the bottom portions 34a, 36a, 34b, 36b, 34c, 36c, 34d, 36d protrude over a greater distance along the width of each slot 20a, 20b, 20c, 20d than the corresponding top portion 30a, 32a, 30b, 32b, 30c, 32c, 30d, 32d. The top portions 30a, 32a, 30b, 32b, 30c, 32c, 30d, 32d of each tapered projection 26a, 28a, 26b, 28b, 26c, 28c, 26d, 28d thus facilitate insertion of one of said boards 100, 102 from the top face 16 of the connector block 10, and the bottom portions 34a, 36a, 34b, 36b, 34c, 36c, 34d, 36d of the tapered projections 26a, 28a, 26b, 28b, 26c, 28c, 26d, 28d pinch both sides of one of said boards 100, 102. Advantageously, having the connector block made of a concrete-based material, rather than wood or other softer material, allows inserting and removing boards (typically made of a softer material) from the connector block without (or with limited) wearing or damaging the slot and/or projections.

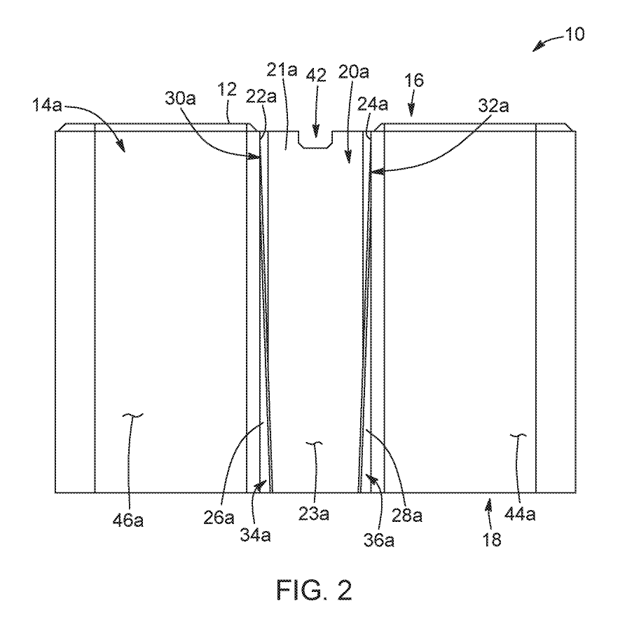

Referring to FIG. 2, the lateral face 14a comprising the slot 20a is shown. There can be seen that the first and second tapered projections 26a, 28a provide greater spacing between top portions 30a, 32a thereof than between bottom portions 34a, 36a thereof. Thus, each one of the boards 100, 102 is preferably sized and configured with a thickness being slightly smaller than the spacing between the top portions 30a, 32a of the first and second tapered projections 26a, 28a. One of the boards 100, 102 can be slidably engaged within the slot 20a from the top face 16 of the connector block 10, toward the bottom face. Each one of the boards 100, 102 also preferably has a thickness slightly larger than the spacing between the bottom portions 34a, 36a of the first and second tapered projections 26a, 28a, thus allowing for a board to be pinched therebetween. It is thus understood that a respective extremity 104, 106 of the boards 100, 102 can be inserted within any one of the slots 20a, 20b, 20c, 20d from the top face 16 of the connector block 10 using, for instance, a hammer and thus being wedged securely therein, as the board is hammered toward the bottom face 18 of the connector block 10.

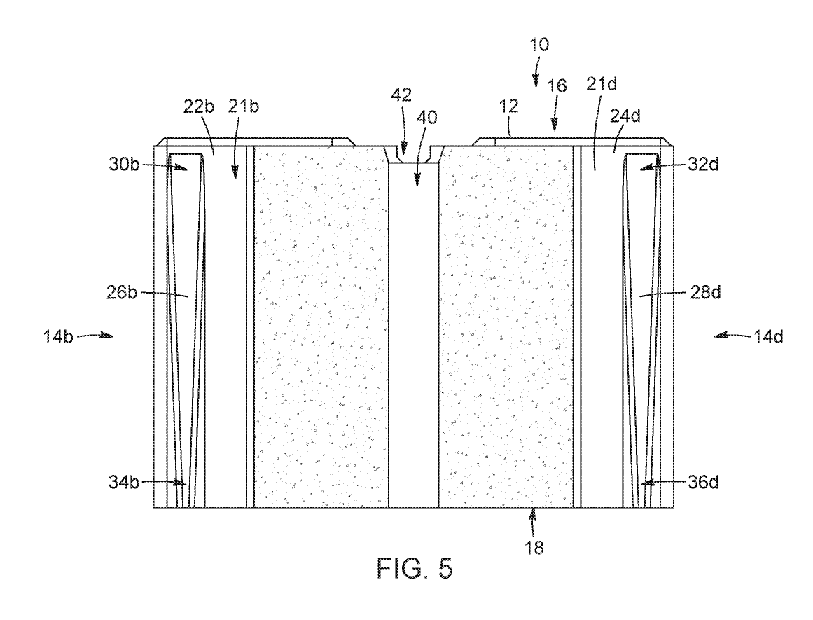

Referring to FIGS. 1 and 5, in the embodiment shown, each one of the tapered projections 26a, 28a, 26b, 28b, 26c, 28c, 26d, 28d has a flat profile toward its corresponding top portion 30a, 32a, 30b, 32b, 30c, 32c, 30d, 32d, and a pointed profile, such as a triangular profile, toward its corresponding bottom portion 34a, 36a, 34b, 36b, 34c, 36c, 34d, 36d. In addition, it can be appreciated in the embodiment shown that each one of the tapered projections 26a, 28a, 26b, 28b, 26c, 28c, 26d, 28d is inwardly tapered. Moreover, each one of the tapered projections 26a, 28a, 26b, 28b, 26c, 28c, 26d, 28d is positioned proximate to the corresponding lateral face 14a, 14b, 14c, 14d (as best shown in FIG. 3 or 4). More particularly, each one of the tapered projections 26a, 28a, 26b, 28b, 26c, 28c, 26d, 28d is slightly spaced away from the corresponding lateral face 14a, 14b, 14c, 14d. In other embodiments of the connector block, the tapered projections can be positioned differently. For instance, in an alternate variant, each one of tapered projections may be defined in a portion of one of the opposed walls that is away from a respective lateral face, closer to the back wall.

Still referring to FIGS. 1 to 5, in the embodiment shown, each one of the bottom portions 34a, 36a, 34b, 36b, 34c, 36c, 34d, 36d of the tapered projections 26a, 28a, 26b, 28b, 26c, 28c, 26d, 28d forms a peak or summit for pinching one of said boards 100, 102. In an alternate variant, the profile of the bottom portion of each one of the tapered projections can be otherwise, for instance being semi-circular, and still allow for an extremity 104, 106 of one of said boards 100, 102 to be wedged securely within a respective slot.

Referring to FIGS. 1 and 4, the body 12 of the connector block 10 is described in further detail. In the implementation shown, the body 12 comprises four corner posts 44, 46, 48, 50. Each one of the slots 20a, 20b, 20c, 20d of a respective one of the lateral faces 14a, 14b, 14c, 14d is formed between adjacent ones of the corner posts 44, 46, 48, 50. More particularly, the body 12 comprises a central post 52 and the four corner posts 44, 46, 48, 50 protrude from the corners of said central post 52. The corner post 44 includes two adjacent exposed faces 44a, 44d and two adjacent inner faces 24a, 22d (identified in FIG. 4). Similarly, the corner post 46 includes two adjacent exposed faces 46a, 46b and two adjacent inner faces 22a, 24b; the corner post 48 includes two adjacent exposed faces 48b, 48c and two adjacent inner faces 22b, 24c; and the corner post 50 includes two adjacent exposed faces 50c, 50d and two adjacent inner faces 22c, 24d. Each pair of adjacent corner posts 44, 46, 48, 50 define the slots 20a, 20b, 20c, 20d extending vertically along the body 12 of the connector block 10. The inner faces 24a, 22d, 22a, 24b, 22b, 24c, 22c, 24d of each one of the corner posts 44, 46, 48, 50 thus include the respective inwardly tapered projections 28a, 26d, 26a, 28b, 26b, 28c, 26c, 28d protruding vertically therefrom.

The body 12 further comprises a through hole 40, extending from the top face 16 to the bottom face 18, for receiving a grounding rod bar. The through hole 40 can be used to pass the grounding rod bar therethrough and thus anchor the connector block 10 on a surface. For instance, the grounding rod bar can be inserted in the through hole 40 and hammered, for instance, in the ground underlying the connector block 10. In the embodiment shown, the through hole 40 is provided in the central post 52.

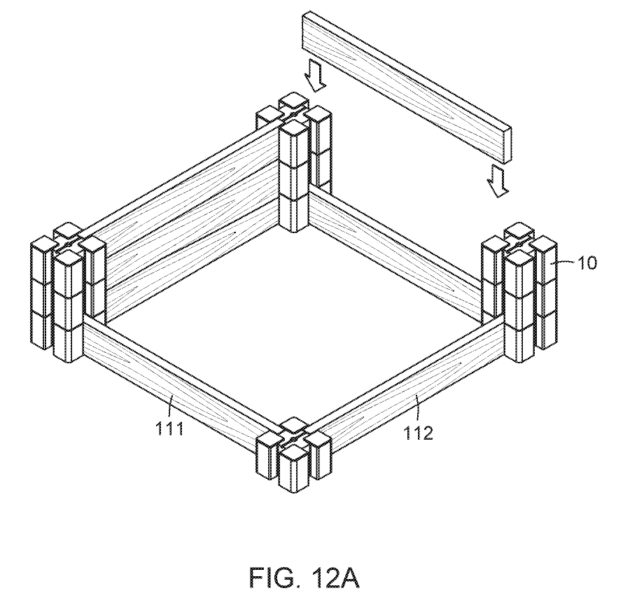

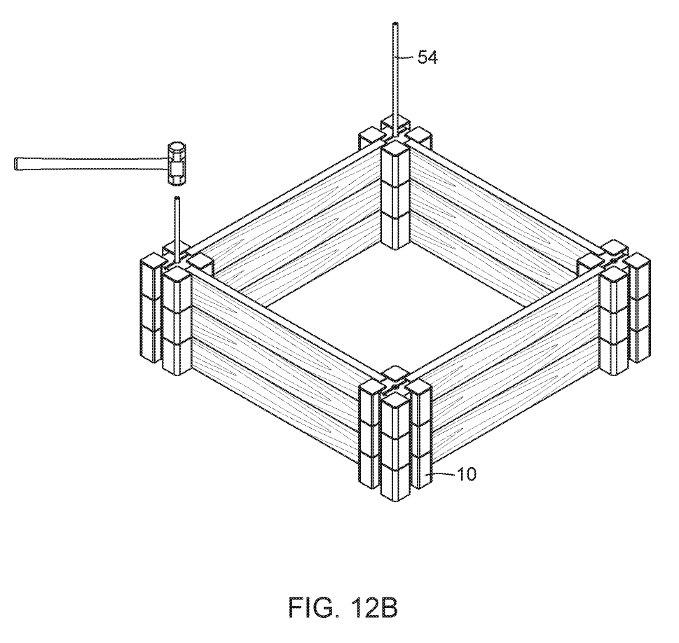

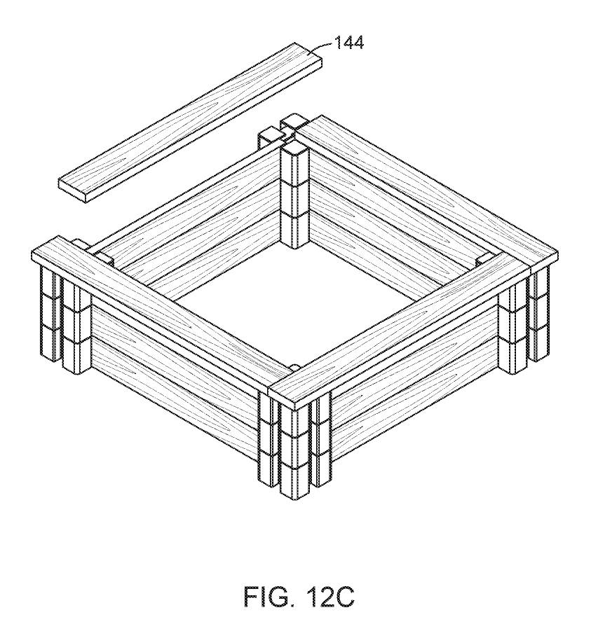

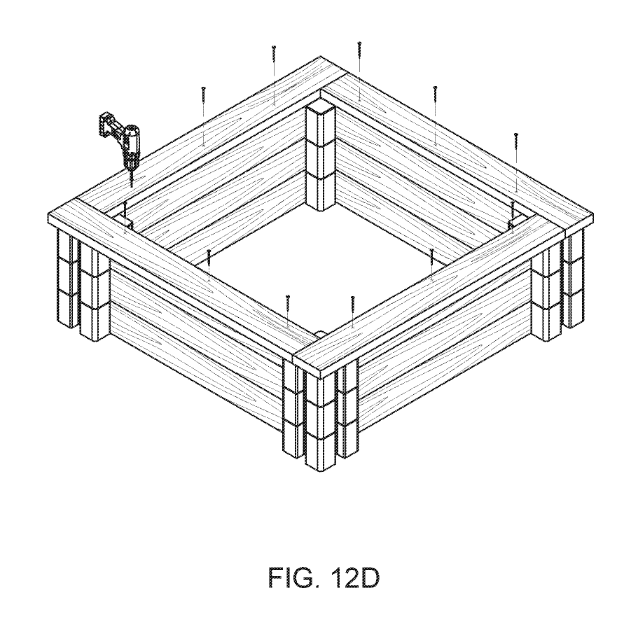

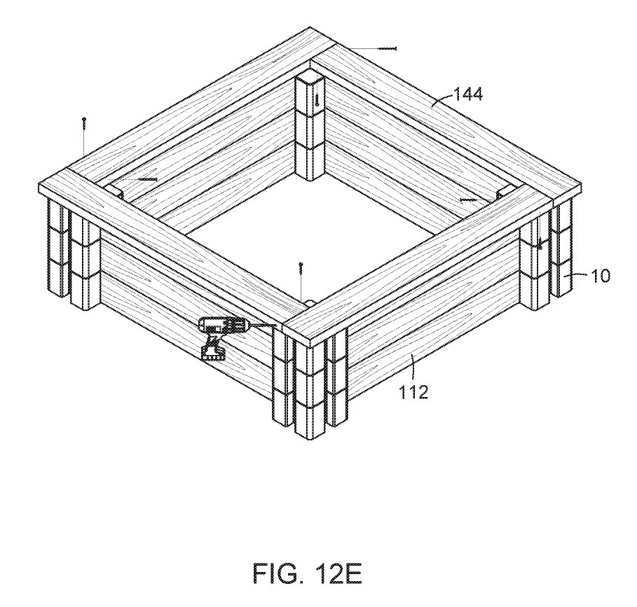

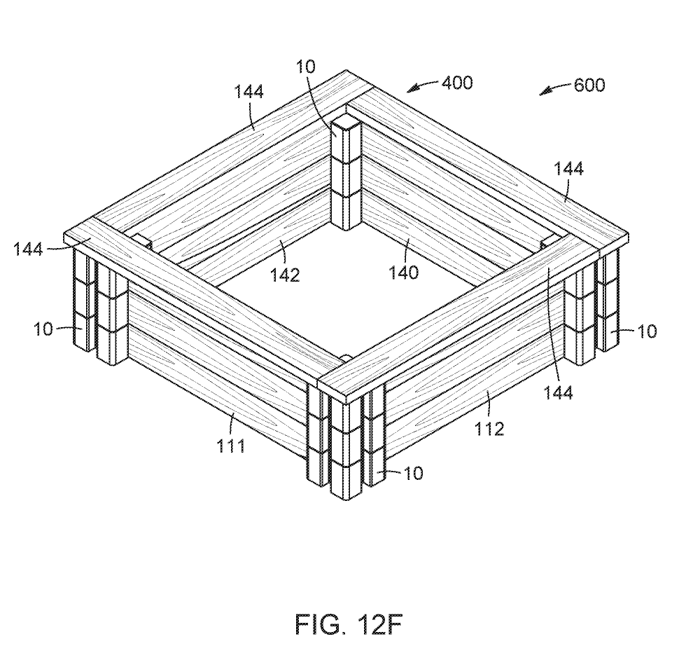

Referring to FIGS. 1 to 5, it can further be appreciated that top face 16 and the bottom face 18 are provided with flat regions or areas, allowing the connector block 10 to be stacked. Thus, a garden bed or a planter box can be formed using a plurality of connector blocks 10 stacked on the top of each other, as illustrated in FIG. 12. Thus, a user can select the overall height of the garden bed or planter by stacking more or less connector blocks and by using more or less boards between adjacent connector blocks. Also, as best shown in FIG. 1, the connector block 10 can include a channel 42 defined on the top face 16 of the body 12. The channel 42 can provide for better drainage of the top face 16 of the body 12.

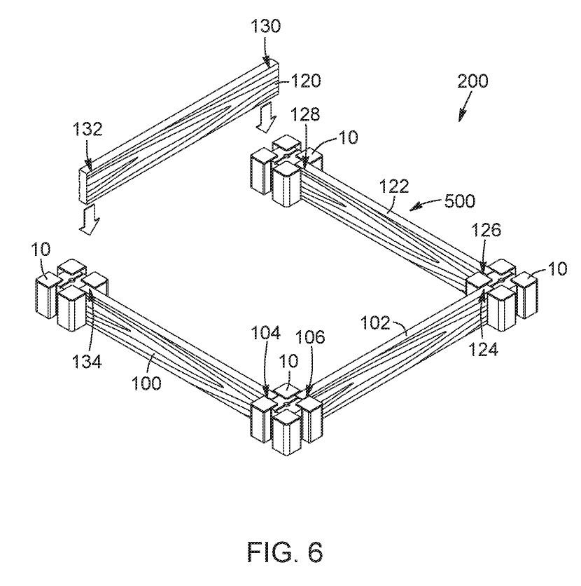

In accordance with yet another aspect, and referring to FIG. 6, an assembly kit 200 for forming a garden bed or a planter box 500 is provided. The assembly kit 200 includes at least four boards 100, 102, 120, 122 and at least four connector blocks 10 as described above. The slots of the four connector blocks 10 are sized and configured to receive a given one of the extremities 104, 106, 124, 126, 128, 130, 132, 134 of the boards 100, 102, 120, 122. The arrows shown on FIG. 6 indicate how a given board, i.e. board 120, has its extremities 130, 132 inserted in the slots of the connector blocks 10, thus forming the garden bed or planter box 500. It can further be appreciated that dismantling the garden bed or the planter box 500 can be convenient since the boards 100, 102, 120, 122 can be disengaged from the connector blocks 10 by sliding them out of the corresponding slot using, for instance, a hammer.

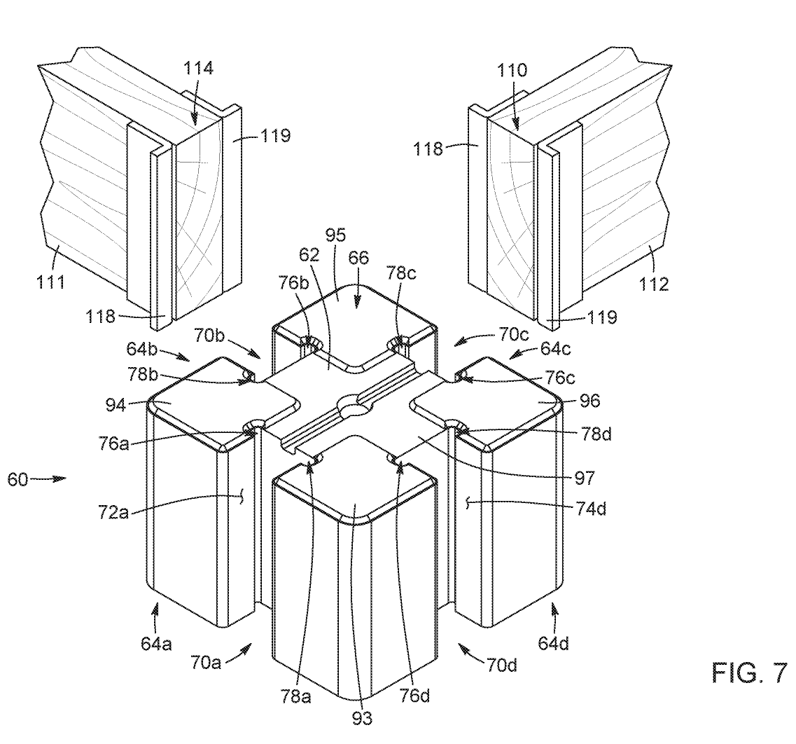

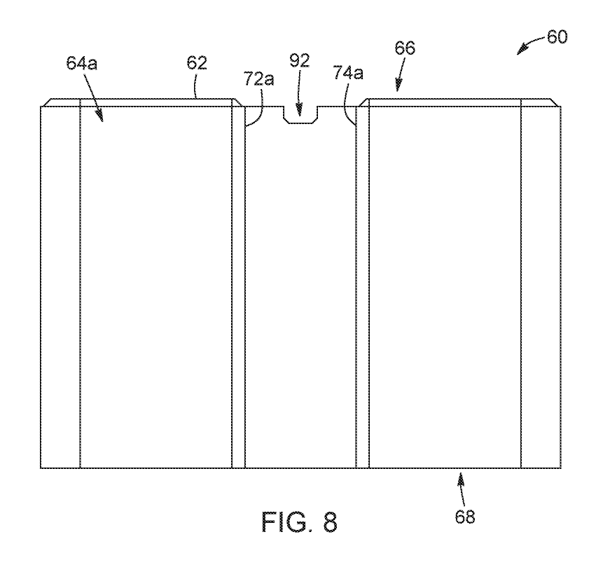

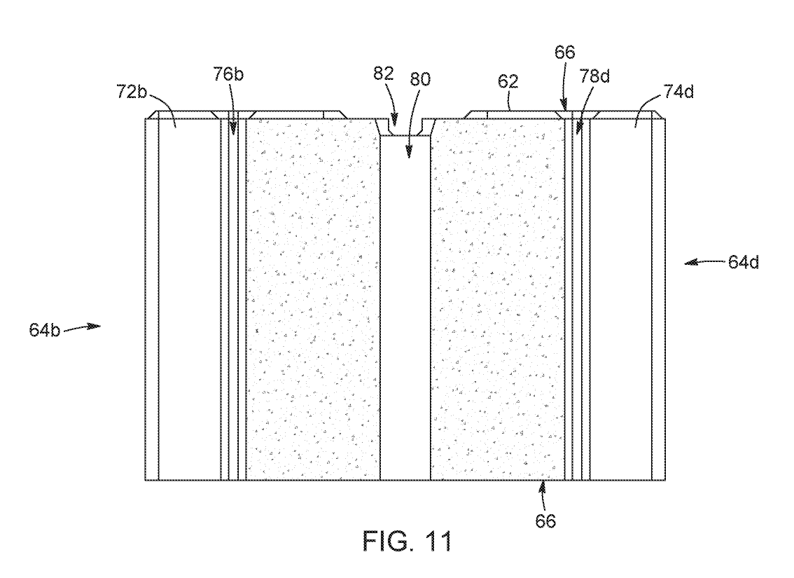

Referring to FIGS. 7 to 11, another possible embodiment of a connector block is shown. The connector block 60 allows joining boards 111, 112 of a garden bed or of a planter box. The boards 111, 112 have opposite extremities (only one extremity 114, 116 of each board 111, 112 is shown in FIG. 7). Each extremity 114, 116 has at least one bracket 118 mounted thereon. In the embodiment shown, two brackets 118, 119 are mounted at each extremity of the boards. The brackets 118, 119 can be mounted on the boards using any type of fasteners, such as screws and/or nails for example. In this example, the brackets are L-shaped brackets, with a first wing of the bracket being affixed on the lateral side of the board, and a second wing extending at 90°, and this second wing being substantially parallel to the end surface of the board.

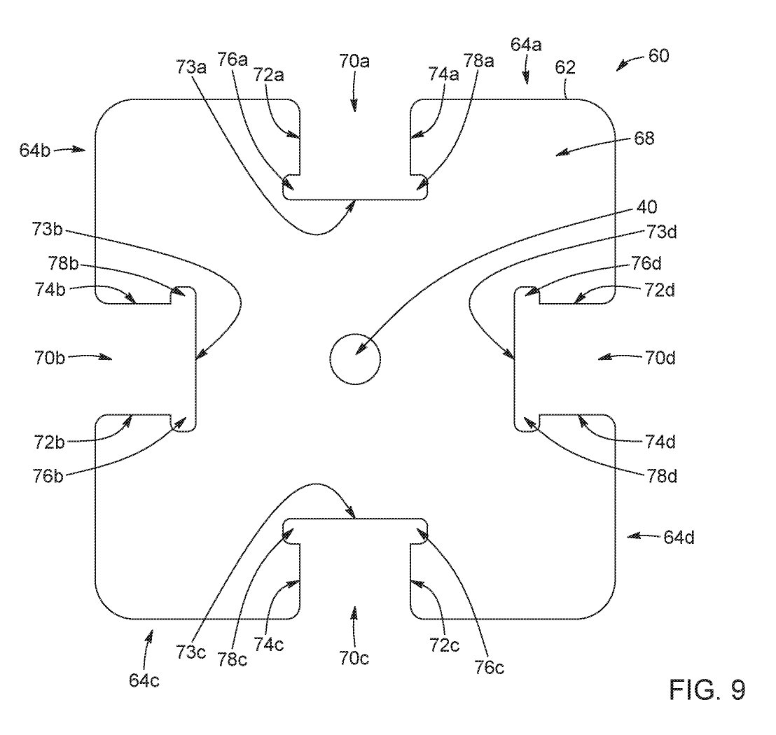

Just as for the first embodiment, the body 62 of the connector block is made or molded from concrete-based material. The body 62 has four lateral faces 64a, 64b, 64c, 64d extending between a top 66 and a bottom face 68. Each one of the four lateral faces 64a, 64b, 64c, 64d comprises a corresponding slot 70a, 70b, 70c, 70d extending vertically from the top face 66 to the bottom face 68. Each one of the slots 70a, 70b, 70c, 70d is defined by corresponding opposed lateral walls 72a, 74a, 72b, 74b, 72c, 74c, 72d, 74d (best shown in FIG. 9) and by a corresponding back wall 73a, 73b, 73c, 73d. Each one of the slots 70a, 70b, 70c, 70d includes at least one recessed portion 76a, 76b, 76c, 76d for receiving the brackets 118, 119 mounted at the extremity of one of the boards 111, 112. In the embodiment shown, each one of the slots 70a, 70b, 70c, 70d includes a first recessed portions 76a, 76b, 76c, 76d and a second recessed portion 78a, 78b, 78c, 78d for receiving the brackets 118, 119 mounted at the extremity 114, 116 of one of said boards 111, 112. It is to be understood that recessed portions 76a, 78a, 76b, 78b, 76c, 78c, 76d, 78d and the slots 70a, 70b, 70c, 70d are sized and configured to receive the extremities 114, 116 and brackets 118, 119 of each one of the boards 111, 112. For instance, the width of each one of the boards 111, 112 can be slightly smaller than the width of one of the slots, allowing the boards 111, 112 with the brackets 118, 119 to be inserted within one of the slots 70a, 70b, 70c, 70d. In addition, the brackets 118, 119 are sized and configured to fit within said at least one recessed portion. For instance, the brackets 118, 119 can have a shape which is complementary to the recessed portions 76a, 78a, 76b, 78b, 76c, 78c, 76d, 78d. Thus, in this embodiment, the recessed portions 76a, 78a, 76b, 78b, 76c, 78c, 76d, 78d and the brackets 118, 119 can provide for advantageous assembly and disassembly of a garden bed or planter box, since no hammering is required to engage or disengage the boards 111, 112 from within the slots 70a, 70b, 70c, 70d.

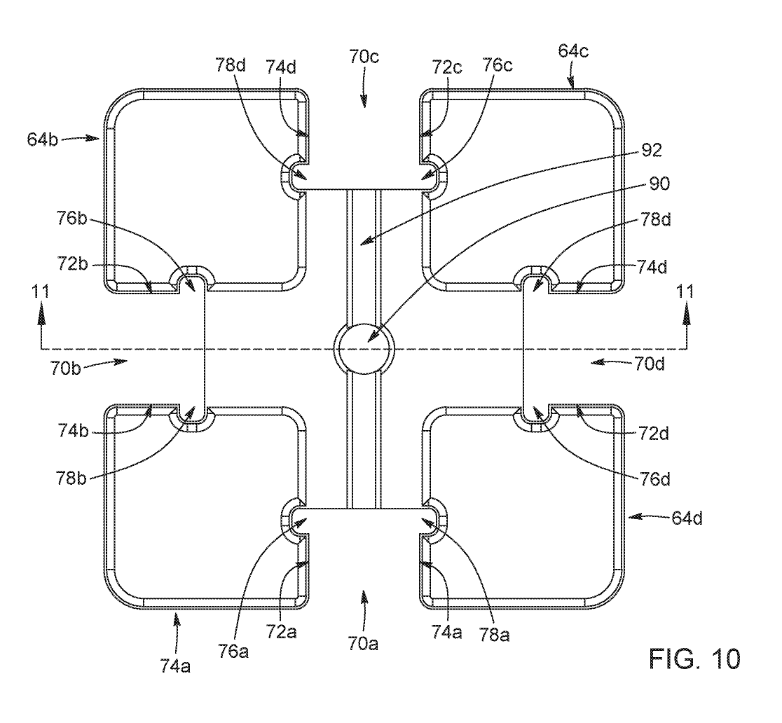

Referring to FIGS. 9 and 10, in the embodiment shown, the first and second recessed portions 76a, 78a, 78b, 78b, 76c, 78c, 76d, 78d are located proximate to the junction of a given lateral wall 72a, 74a, 72b, 74b, 72c, 74c, 72d, 74d and the corresponding back wall 73a, 73b, 73c, 73d defining the corresponding slot 70a, 70b, 70c, 70d. It is understood that in an alternate variant, the recessed portions can be located proximate to the junction of one of the lateral walls and one of the lateral faces. Referring back to the illustrated embodiment, the first and second recessed portions 76a, 78a, 78b, 78b, 76c, 78c, 76d, 78d extend vertically over the entire height of the connector block 60. Moreover, the first and second recessed portions 76a, 78a, 78b, 78b, 76c, 78c, 76d, 78d are respectively located at junctions of each one of the opposed lateral walls 72a, 74a, 72b, 74b, 72c, 74c, 72d, 74d and of the corresponding back wall 73a, 73b, 73c, 73d.

Still referring to FIGS. 9 and 10, in this particular embodiment, the slots 70a, 70b, 70c, 70d have a T-shape when viewing the connector block 60 from the top face 66 or the bottom face 68. In addition, similar to the first embodiment described previously, the connector block 60 includes a through hole 90 extending through the body 62, from the top face 66 to the bottom face 68. Again, said through hole 90 can allow for the passage of a grounding rod bar for anchoring the connector block 60.

Referring to FIG. 7, a channel 94 is also defined on the top face 66 of the body 62. The channel 94 can provide for better drainage of the top face 66 of the body 12.

In accordance with another aspect and still referring to FIG. 7, the body 62 comprises a central post 97 and four corner posts 93, 94, 95, 96 extending from the central post. Each one of the slots 70a, 70b, 70c, 70d is formed between adjacent ones of said four corner posts 93, 94, 95, 96. Furthermore, at least one recessed portion can formed on an inner side of a corresponding one of said corner posts 93, 94, 95, 96. For instance, in the embodiment shown, each one of the first and second recessed portions 76a, 78a, 78b, 78b, 76c, 78c, 76d, 78d is formed on the inner side of a corresponding one of said corner posts 93, 94, 95, 96.

In accordance with yet another aspect and referring to FIGS. 12A to 12F, an assembly kit 400 for forming a garden bed or a planter box 600 is shown. The method for assembling a planter box or a garden bed will also be described with reference to FIGS. 12A-12F. It will be noted that while embodiment of the connector block shown in FIGS. 12A-12F is the one from FIGS. 1 to 5, the different embodiments described previously can be used. The assembly kit comprises at least four boards 111, 112, 140, 142, at least four connector blocks 10, and four grounding rod bars 54. As mentioned above, each one of the slots and recessed portions of the at least four connector blocks 10 are sized and configured to receive the extremities of the boards. The slots may be provided or not with tapered projections and/or with recessed portions to accommodate brackets mounted at the extremity of the boards.

Referring to FIG. 12A, four connector blocks are first placed at each corner of the future garden bed. Then, four boards are slid into the slots of the connector blocks, forming the first row of blocks and boards. Additional layers of blocks and boards are stacked, until the garden bed has the height desired. Then, as shown in FIG. 12B, grounding rod bars are inserted in the through holes of the connector blocks, and forced into the ground to stabilize the assembly. The grounding rod bars may have to be hammered to be buried deep enough into the ground. As shown in FIGS. 12C, 12D and 12E, top boards or planks can be placed flat on the top layer of lateral boards, in order to close and delimit the upper edge of the garden bed. The top boards are preferably placed on top of the connector blocks, and affixed with nails or screws.

As best shown in FIG. 12F, the completed garden bed or the planter box 600 is thus formed of a plurality of connector blocks 60 and boards 111, 112, 140, 142 stacked on top of each other. By stacking several connectors one on top of the other, the height of the garden bed or planter box can be selected according to the user's need. In this embodiment, the top faces of the uppermost connector blocks 10 are covered with top boards 144 similar to the boards 111, 112, 140, 142 forming the sidewalls of the garden bed or the planter box 600. These top boards 144 can be secured to the underlying boards 111, 112, 140, 142 using, for instance, fasteners. These top boards 144, in addition to the grounding rod bars, thus provide a better structural integrity to the garden bed or the planter box 600 while being aesthetically pleasing.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the invention. The scope of the invention is therefore intended to be limited solely by the scope of the appended claims.

The invention claimed is:

1. A connector block for assembling a garden bed or a planter box, for use in combination with boards and grounding rod bars, the connector block comprising:
a body comprising concrete-based material, the body having four lateral faces extending between a top face and a bottom face and a through hole extending from the top face to the bottom face, for receiving one of the grounding rod bars;
each of the four lateral faces comprising a slot extending vertically from the top face to the bottom face, for receiving an extremity of one of said boards, each slot being defined by a continuous slot wall which is recessed from a corresponding one of said four lateral faces.

2. The connector block according to claim 1, wherein the body comprises four corner posts, the slot of a respective one of the lateral faces being formed between adjacent ones of said corner posts.

3. The connector block according to claim 2, wherein the body comprises a central post, the four corner posts protruding from corners of said central post, and the through hole being provided in said central post.

4. The connector block according to claim 3, wherein the four corner posts have respective top flat top surfaces, allowing the connector block to be stacked.

5. The connector block according to claim 4, wherein the central post has a top surface which is recessed relative to the top flat surfaces of the four corner posts.

6. The connector block according to claim 5, wherein the slot wall comprises a two opposed lateral walls part of the adjacent corner posts and a back wall part of the central post.

7. The connector block according to claim 6, wherein each slot has at least one recessed portion for receiving a bracket mounted at the extremity of one of said boards.

8. The connector block according to claim 7, wherein the at least one recessed portion is located proximate to a junction of one of the opposed lateral walls and the back wall defining the slot.

9. The connector block according to claim 7, wherein said at least one recessed portion extends vertically over an entire height of the connector block.

10. The connector block according to claim 7, wherein the at least one recessed portion comprises first and second recessed portions, respectively located at junctions of the opposed lateral walls and of the back wall.

11. The connector block according to claim 1, wherein the slot has a T-shape when viewing the connector block from the top face.

12. The connector block according to claim 7, wherein said at least one recessed portion is formed on an inner side of a corresponding one of said corner posts.

13. The connector according to claim 1, wherein the slot wall comprises at least one tapered projection protruding therefrom and extending vertically along at least a portion of the slot, for wedging at least one lateral side of one of said boards.

14. The connector block according to claim 13, wherein the slot wall comprises two opposed lateral walls and a back wall, and wherein said at least one tapered projection comprises first and second tapered projections, each provided on a respective one of said opposed lateral walls, for wedging both lateral sides of one of said boards.

15. The connector block according to claim 14, wherein the two opposed lateral walls of the slot wall define a width of the slot, and wherein the at least one tapered projection has a top portion proximate to the top face and a bottom portion proximate to the bottom face, the bottom portion protruding over a greater distance along said width than the top portion, the top portion of the first and second tapered projections facilitating insertion of one of said boards from the top face of the connector block and the bottom portion of the first and second tapered projections pinching both lateral sides of one of said boards.

16. The connector block according to claim 13, wherein the at least one tapered projection has a flat profile toward its top portion, and a triangular profile toward the bottom portion of the at least one tapered projection.

17. The connector block according to claims 13, wherein the at least one tapered projection is inwardly tapered.

18. The connector block according to claim 13, wherein the at least one tapered projection is positioned proximate to the lateral face.

19. The connector block according to claim 13, wherein the at least one tapered projection is slightly spaced away from the lateral face.

20. The connector block according to claim 15, wherein the bottom portion of the at least one tapered projection forms a peak for pinching one of said boards.

21. A connector block for joining boards of a garden bed or of a planter box, the connector block comprising:
a body comprising concrete-based material, the body comprising a central post having a through hole extending therein and four corner posts protruding therefrom, each of the corner post comprising two adjacent exposed faces and two adjacent inner faces, said body having a top face and a bottom face;
each pair of adjacent corner posts defining a slot extending vertically along the body of the connector block, for receiving one of the boards.

22. An assembly kit for forming a garden bed or a planter box, comprising:
at least four boards;
at least four connector blocks as defined in claim 1, the slots of the four connector blocks being sized and configured to receive a given one of the extremities of the boards; and
at least four grounding rods for insertion into the through holes of connector blocks.
